(19) United States
(12) Patent Application Publication
(10) Pub. No.: US 2002/0046066 A1
(43) Pub. Date: Apr. 18, 2002

(54) Reinsurance and risk management method

(75) Inventor: Vincent L. Laurenzano, Flushing, NY (US)

Correspondence Address: DARBY & DARBY P.C., 805 Third Avenue, New York, NY, 10022, US

(73) Assignee: Recovery National Corporation

(21) Appl. No.: 09/949,146

(22) Filed: Sep. 7, 2001

Related U.S. Application Data
(60) Provisional application No. 60/231,014, filed on Sep. 8, 2000.

(51) Int. Cl. G06F 17/60

(52) U.S. Cl. 705/4

(57) ABSTRACT

The method manages risk of loss by providing an amount of indemnification, determining an amount of unrealized economic benefit, and reducing the amount of indemnification by the determined amount of unrealized economic benefit. As applied to reinsurance, the reinsurer indemnifies the insurer for a maximum amount relating to a risk of loss. The reinsurer identifies an amount of unrealized reinsurance and this amount reduces the maximum amount.

This application claims priority pursuant to 35 U.S.C. §119 from U.S. Provisional Patent Application Serial No. 60/231,014 filed Sep. 8, 2000, the entire disclosure of which is hereby incorporated by reference.

### FIELD OF THE INVENTION

The present invention is directed to a business method relating to the insurance industry and in particular to the reinsurance aspect.

### BACKGROUND OF THE INVENTION

Reinsurance is insurance for an insurance company. More technically, reinsurance can be defined as:

The transaction whereby the reinsurer, for a consideration (premium), agrees to indemnify the ceding company (the insurer seeking reinsurance, or cedent) against all or part of the loss that the latter may sustain under the policy or policies which it has issued.

Reinsurance contracts impose a reporting obligation on the part of the cedent. The cedent is expected to identify and report those losses that are applicable to the reinsurance contract. The cedent establishes an administrative process for this purpose, often by creating a dedicated reinsurance identification and reporting unit or by delegating those responsibilities to an existing department (e.g. claims).

Despite such measures, identifying every loss to its applicable reinsurance contract(s) can be a challenge for a cedent. Factors such as transaction volume, data completeness and integrity, reinsurance program complexity, and resource constraints often will cause a cedent to utilize its purchased reinsurance program sub-optimally. Over time it is possible for a cedent to accumulate a meaningful amount of unrealized reinsurance, or losses that could have been identified to a reinsurance contract but were not.

Sub-optimal utilization of a purchased reinsurance program of indemnification, or the occurrence of unrealized reinsurance, is an exposure, or risk, that should be amenable to standard risk management techniques. In general, an entity that confronts a potential exposure can retain the risk or seek to transfer the risk through a risk transfer mechanism (e.g., an indemnity contract).

If the risk is retained, the entity can take affirmative steps to mitigate the frequency and/or the potential severity of losses associated with the exposure (so-called “loss control” methods). In the case of unrealized reinsurance, a cedent seeking to mitigate its possible losses will audit its reinsurance identification process on a periodic basis. The audit will most likely focus on the treatment of material losses already identified rather than losses that could have been identified to a reinsurance contract but were not. If adequate resources are available, a cedent may also undertake at reasonable intervals a limited retrospective evaluation of its reinsurance identification process as a whole in an effort to assess whether the process has performed as expected. Such affirmative steps are rarely completely effective, and, over time, the losses resulting from unrealized reinsurance are often substantial.

No risk-transfer mechanism currently exists that allows a cedent to transfer its exposure to sub-optimal utilization of its purchased reinsurance program. Therefore, it is desirable to provide a method for a cedent to transfer the risk of unrealized reinsurance through a contract of indemnity (i.e., a reinsurance contract). Such a contract would enable the cedent to manage the financial risk of unrealized reinsurance and provide access to economically efficient loss control methods.

### SUMMARY OF THE INVENTION

The present invention is a method for managing an entity's risk of loss due to an unrealized economic benefit. The provider indemnifies the entity for a value relating to the risk up to a maximum amount. Typically the entity provides some consideration to the provider in return. This consideration may be determined based on the value of indemnification and/or the risk. The provider determines the amount of the unrealized economic benefit. Such determination includes identifying the economic benefit to which the entity is entitled, for example, receivables or overpayments, and for which the entity did not assert its entitlement. The maximum amount is then reduced by the amount of determined unrealized economic benefit.

In the insurance business, the provider, i.e., reinsurer, indemnifies the reinsured/cedent for a loss up to some limit and this limit will be offset by any identified unrealized reinsurance. The reinsurer then identifies unrealized reinsurance that inures to the benefit of the cedent and determines the offset.

### BRIEF DESCRIPTION OF THE DRAWINGS

FIG. 1 is a block diagram illustrating the insurance and reinsurance arrangement according to an embodiment of the present invention;

FIG. 2 is a flow diagram illustrating the method of risk management and reinsurance in accordance with an embodiment of the present invention; and

FIG. 3 is a collection of graphs illustrating the method in accordance with a further embodiment of the present invention.

### DETAILED DESCRIPTION OF EMBODIMENTS OF THE PRESENT INVENTION

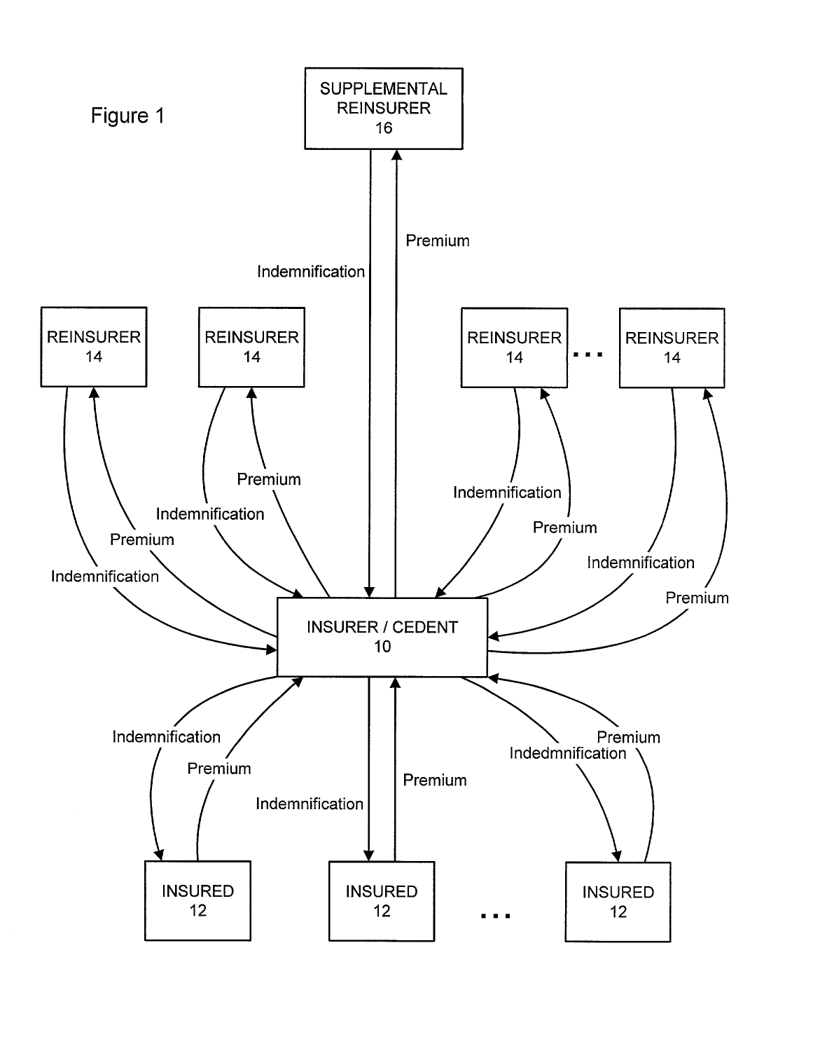

In the preferred embodiment of the present invention, an insurer manages its risk of loss by obtaining indemnification wherein the limit of indemnification is offset by unrealized reinsurance. The typical insurance and reinsurance arrangement is illustrated in FIG. 1. The insurer/cedent 10 provides insurance policies for one or more entities or insureds 12. The insured pays an insurance premium and the insurer indemnifies the insured for losses, if any, in accordance with the terms and conditions specified in the insurance policy. In turn, the insurer 10 obtains indemnification for some or all losses relating to one or more policies by purchasing reinsurance from one or more reinsurers 14. The insurer pays a part of the premium(s) received from the insured(s) to the reinsurer and the reinsurer indemnifies the insurer for a specified amount referred to here as the limit. The reinsurance arrangement as well as the terms and conditions are memorialized in a reinsurance contract between the insurer and reinsurer.

FIG. 1, further illustrates one entity 16, referred to here as the supplemental reinsurer, providing reinsurance separate from the underlying reinsurers 14, and triggered typically after all other underlying reinsurance has been paid to the cedent. The supplemental reinsurer 16 provides reinsurance wherein the aggregate limit may be offset by certain unrealized reinsurance with respect to the underlying reinsurers 14. The terms and conditions of the offset may be memorialized in the reinsurance contract or in a separate contract. The contract authorizes the supplemental reinsurer 16 to access the appropriate records in order to conduct an investigation for this purpose. The appropriate records include those involving agreements or transactions between the insurer 10 and the insured 12 as well as between the insurer 10 and the underlying reinsurers 14. Once the unrealized reinsurance is identified, a recovery process may be initiated to realize or recover those entitlements or proceeds.

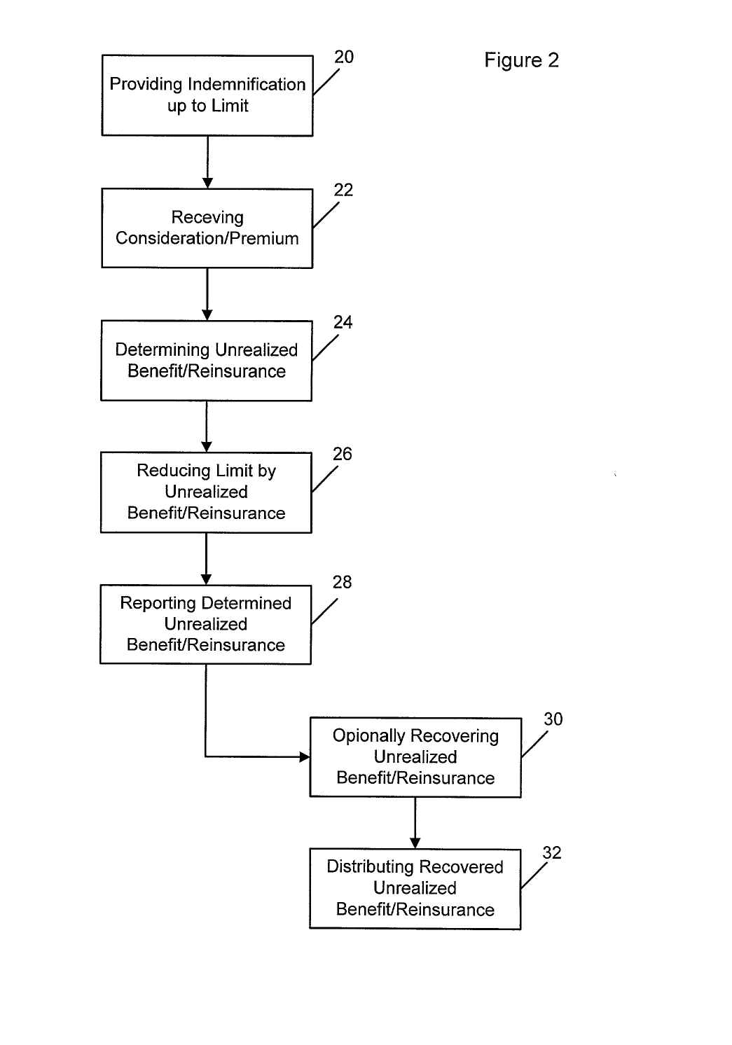

FIG. 2 further illustrates the method involved in offsetting unrealized reinsurance or other economic benefit. At step 20, the supplemental reinsurer indemnifies the insurer for losses up to a predetermined amount X, or aggregate limit. At step 22, the supplemental reinsurer receives some consideration or premium from the insurer. Over the pertinent duration (based on the contract) the supplemental reinsurer is afforded access to and reviews the insurer's relevant records and the insurer reports relevant transactions to the supplemental reinsurer. Through record review, at step 24, the supplemental reinsurer determines the economic benefit, e.g., unrealized reinsurance on policies or contracts between the insurer and the other one or more underlying reinsurers. At step 26, the aggregate limit is reduced by the determined unrealized reinsurance. At step 28, information regarding the determined unrealized reinsurance is provided or reported to the insurer/cedent. Optionally, at step 30, the supplemental reinsurer proceeds to recover (or attempt to recover) the unrealized reinsurance. This step includes noticing or billing the appropriate underlying reinsurer and collecting the entitled reinsurance. This step may result in collecting some, all or no portion of the unrealized reinsurance. After recovery performed at step 30, the supplemental reinsurer may distribute the recovery according to the appropriate contract terms.

For determining unrealized reinsurance, the supplemental reinsurer reviews all the relevant reinsurance agreements and makes an assessment of the coverage. Relevancy may be determined by the terms of the contract. For example, the contract may specify that it applies to the policies that cover certain types of losses, or claims that are valued within a certain range, and all reinsurance relating to those policies. The insurance policies pertaining to the relevant reinsurance and the claims received by the insurer on those policies are also reviewed. A comparison of these records may result in the identification of unrealized reinsurance or other economic benefit. For example, a discrepancy between the insurer's losses and amount of reinsurance collected in connection with those losses may be unrealized reinsurance. Losses include paid and unpaid losses and loss adjustment expenses on claims with respect to covered policies.

The parties may agree to some definition as to which unrealized benefits qualify for the offset. For example, the contract may allow for any reinsurance or recoverable amount not previously identified by the insurer. Alternatively, the contract may restrict the unrealized reinsurance to those reinsurance and recoverable amounts that the insurer notices or bills to the appropriate reinsurer. In such arrangement, the insurer may be afforded the opportunity to validate the identified unrealized reinsurance. With reference to FIG. 2, after step 24 of determining unrealized reinsurance, the supplemental reinsurer reports to the insurer the information pertaining to the identified unrealized reinsurance. The insurer may then verify or validate some, all or no part of such unrealized reinsurance. The validated unrealized reinsurance is then applied at step 26 to reduce the aggregate limit. These reports may include proof suitable for providing to the appropriate underlying reinsurer for purposes of billing and collection.

In effect, the preferred embodiment of the present invention combines loss control methodologies directed toward unrealized reinsurance or other economic benefit and a risk management contract. In this embodiment, the reinsurance contract reduces, through risk transfer, the risk associated with sub-optimal utilization of purchased, ceded reinsurance. Furthermore, the management of unrealized reinsurance risk is integrated into the cedent's overall reinsurance program. Another effect is the more appropriate matching of the economic benefits and the economic costs of reinsurance. This method additionally provides an efficient mechanism for cedents to gauge and incorporate in their own product pricing algorithms the cost of unrealized reinsurance.

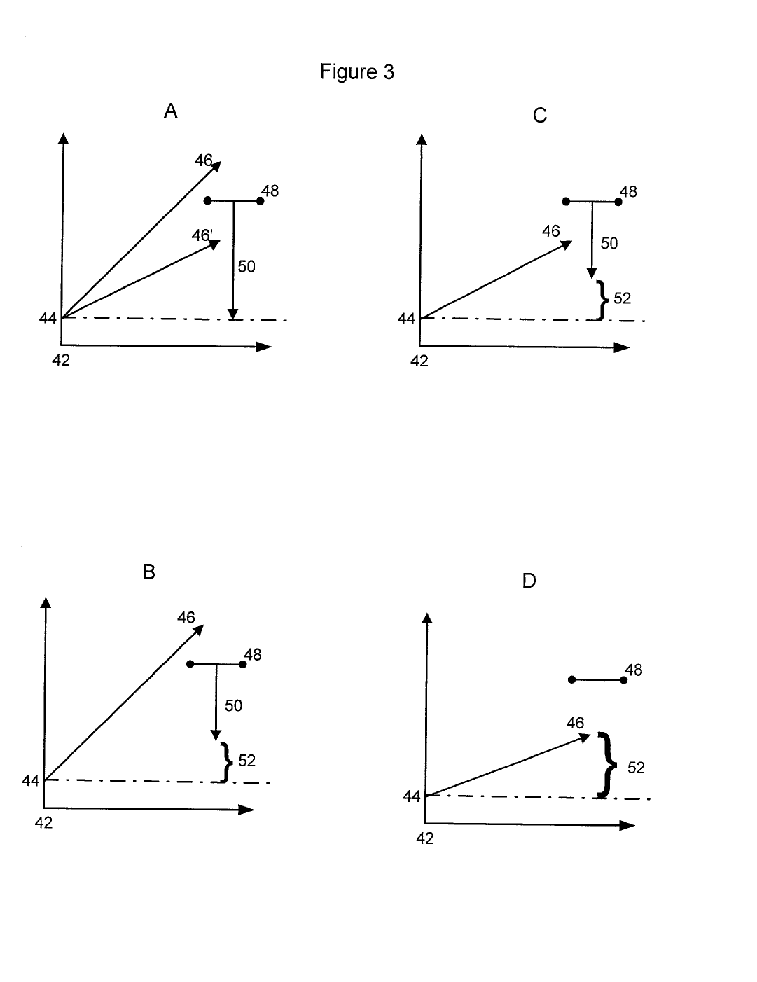

In a further embodiment of the present invention, the indemnified loss is defined with respect to the insurance policies and reinsurance contacts. FIG. 3 illustrate exemplary scenarios of this embodiment using a graph wherein the horizontal axis represent time and the vertical axis represents economic value. In this embodiment, the indemnification applies to losses covered by policies issued by the insurer after an inception date and prior to an Effective Date 42. Retention 44 is the amount of the insurer's current net outstanding losses as of the Effective Date. Retention represents a net amount in that it reflects the reinsurance benefit the insurer has recorded on its books as of the Effective Date. The Ultimate Net Loss 46 is the actual loss paid or to be paid on the insurer's net retained liability (i.e., Retention). The Ultimate Net Loss is measured at a date subsequent to the Effective Date. The Aggregate Limit 48 is an amount of indemnification agreed to by the supplemental reinsurer and the insurer. The Aggregate Limit represents the maximum potential payout amount by the supplemental reinsurer to the insurer. The supplemental reinsurer indemnifies the insurer for the amount of Ultimate Net Losses that exceeds the Retention up to the Aggregate Limit.

The Offset 50 is the amount of qualifying unrealized reinsurance identified by the supplemental reinsurer. The Offset is indicated with an arrow pointing down from the Aggregate Limit to represent a reduction of the amount of Aggregate Limit in the amount of the Offset. The graphs in FIG. 3 show that the maximum payout by the supplemental reinsurer to the insurer is a function both of the Ultimate Net Loss and the Offset. In the simplest case, graph A, the Offset 50 is equal to the Aggregate Limit 48, therefore the payout amount is reduced to zero regardless of the Ultimate Net Loss (46 or 46′). In exemplary graph B, the difference between the Ultimate Net Loss and the Retention is greater than the Aggregate Limit 48, therefore the maximum payout is equal to the Aggregate Limit, except for the Offset which reduces the required payout to the resulting amount 52. In exemplary graph C, the difference between the Ultimate Net Loss and the Retention is less than the Aggregate Limit, therefore the maximum payout is equal to the difference between the Ultimate Net Loss and the Retention, except for the Offset, which reduces the required payout to the resulting amount 52. In exemplary graph D, there is no offset, so the maximum payout is equal to the difference between the Ultimate Net Loss and the Retention up to the Aggregate Limit.

Such contractual arrangement, as described with reference to FIG. 3, is called an excess of loss contract of indemnification. However the present invention is applicable to other reinsurance contracts or other financial instruments involving indemnification and a risk management service, the financial flows of which are indeterminate with respect to amount and time.

The cedent/reinsured pays a premium for the reinsurance as well as the loss control methodologies for determining unrealized reinsurance. The premium may be determined based on the indemnified loss and/or aggregate limit. Recoveries of unrealized reinsurance may obligate the cedent/reinsured to pay the reinsurer additional consideration (e.g., additional premiums and/or profit share) under such an excess of loss reinsurance contract. For example, the contract may require an initial premium payable by the insured to the reinsurer for the reinsurance provided by the reinsurance contract. Additional consideration may be payable by the insured to the reinsurer according to a graduated scale based on the amount of unrealized reinsurance actually collected by the insured. The amount of unrealized reinsurance is preferably a cumulative amount. The graduated additional consideration scale may be mutually agreed upon between the insured and the reinsurer. For example, a graduated premium scale may have three tiers and the premium would be the sum of the products.

Aside from unrealized reinsurance, there are other unrealized economic benefits conducive to such loss control methodology arrangements. Examples include premium audit services, direct claims review services, subrogation review services, and direct policy deductible review services. A premium audit examines an insurer's records in order to make sure the insurance company is receiving all the premiums it is owed. Direct claims are losses applicable towards an insured's policy. A direct claims review examines the claims made on an insurance company in order to determine whether the losses reported were appropriate. Subrogation is the compensation an insurer is owed by another insurance company when the insurer awards money on a claim for which it is not directly or indirectly liable (e.g., on a car accident in which another driver is at fault). A subrogation review insures that an insurer is receiving all the subrogation it is owed. A deductible is the dollar amount above which an insurance policy covers a loss. A direct claim deductible review insures that an insurer has not been reimbursing clients on claims below the deductible.

It is understood from the disclosure provided herein that other embodiments are also contemplated by and with the scope of the invention. Moreover, the present invention is not limited to any particular type of insurance coverage or loss control methodology, but is applicable to any type of insurance for which reinsurance may be provided and to any type of loss control methodology.

While the novel features of the present invention as applied to the preferred embodiment thereof have been shown and described, it will be understood that various omissions, substitutions, and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all the statements of the scope of the invention which, as a matter of language, might be said to fall there between.

What is claimed is:

1. A method for managing risk for an entity comprising the steps of:
a. indemnifying the entity for a value relating to the risk up to a maximum;
b. receiving a consideration from the entity;
c. determining an amount of an unrealized economic benefit; and
d. reducing the maximum by the amount of the unrealized economic benefit.

2. The method of claim 1, further comprising the step of identifying said unrealized economic benefit to which the entity is entitled and for which the entity did not assert its entitlement.

3. The method of claim 2, further comprising the steps of:
a. providing to the entity an identification of said identified economic benefit;
b. receiving from the entity a validation for said identified economic benefit that the identified economic benefit is a validated economic benefit; and
c. determining that the validated economic benefit is applicable to reduce the maximum.

4. The method of claim 1, further comprising the step of identifying as said economic benefit one or more receivables uncollected by the entity from, or overpayments made by the entity to, another entity for which the entity did not seek collection or reimbursement.

5. The method of claim 1, further comprising the step of determining the consideration in accordance with the value of indemnification and the risk.

6. A method for providing reinsurance for an insurer comprising the steps of:
a. indemnifying the insurer for a net loss up to an aggregate limit;
b. receiving a premium from the insurer;
c. determining an amount of unrealized reinsurance inured to the benefit of the insurer; and
d. reducing the aggregate limit by the amount of unrealized reinsurance.

7. The method of claim 6, further comprising the step of allocating a percentage of the amount of unrealized reinsurance for the insurer.

8. The method of claim 6, further comprising the steps of:
a. identifying said unrealized reinsurance;
b. providing to the insurer an identification of said identified unrealized reinsurance;
c. receiving from the insurer a validation for said identified unrealized reinsurance that the identified unrealized reinsurance is a validated unrealized reinsurance; and
d. determining that the validated unrealized reinsurance is applicable to reduce the aggregate limit.

9. The method of claim 6, further comprising the steps of:
a. recovering a portion of the amount of unrealized reinsurance; and
b. receiving additional premium or profit share according to a graduated scale based on the portion of recovered unrealized reinsurance.

10. The method of claim 6, further comprising the step of receiving additional premium or profit share according to a graduated scale based on an amount of recovered unrealized reinsurance.

11. A method for recovering reinsurance for an insurer comprising the steps of:
a. indemnifying the insurer for a net loss up to an aggregate limit;
b. determining an amount of unrealized reinsurance inured to the benefit of the insurer;
c. reducing the aggregate limit by the amount of unrealized reinsurance;
d. recovering the amount of unrealized reinsurance; and
e. providing a determined percentage of the recovered reinsurance to the insurer.

12. The method of claim 11, further comprising the steps of:
f. reviewing a plurality of reinsurance agreements entered into by the insurer;
g. reviewing a plurality of claims received by the insurer; and
h. identifying as said unrealized reinsurance a value that inured to the benefit of the insurer under one of said reinsurance agreements for a loss relating to one of said claims.

13. The method of claim 11, further comprising the step of receiving a premium from the insurer wherein said premium is determined in accordance with the indemnified loss or the aggregate limit.

14. The method of claim 11, further comprising the step of receiving a premium from the insurer wherein said premium is determined based on the amount of recovered unrealized reinsurance.

15. A method for providing a loss control methodology to an insurer comprising the steps of:
a. indemnifying the insurer for a net loss up to an aggregate limit minus an offset;
b. identifying unrealized reinsurance inured to the benefit of the insurer; and
c. determining the offset based on the identified unrealized reinsurance.
